(19) United States
(12) Patent Application Publication
(10) Pub. No.: US 2015/0268827 A1
(43) Pub. Date: Sep. 24, 2015

(54) METHOD FOR CONTROLLING MOVING DIRECTION OF DISPLAY OBJECT AND A TERMINAL THEREOF

(71) Applicant: HiDeep Inc., Gyeonggi-do (KR)

(72) Inventors: Seyeob Kim, Gyeonggi-do (KR); Sangsic Yoon, Gyeonggi-do (KR); Sunyoung Kwon, Gyeonggi-do (KR); Hojun Moon, Gyeonggi-do (KR); Taehoon Kim, Gyeonggi-do (KR); Bonkee Kim, Gyeonggi-do (KR)

(21) Appl. No.: 14/623,781

(22) Filed: Feb. 17, 2015

(30) Foreign Application Priority Data
Mar. 24, 2014 (KR) 1020140034169
Apr. 22, 2014 (KR) 1020140048361
May 9, 2014 (KR) 1020140055732
Aug. 1, 2014 (KR) 1020140098917
Sep. 19, 2014 (KR) 1020140124920
Oct. 24, 2014 (KR) 1020140145022
Dec. 22, 2014 (KR) 1020140186352

(51) Int. Cl. G06F 3/0484; G06F 3/0488

(52) U.S. Cl. CPC G06F 3/04845; G06F 3/0488; G06F 3/04847; G06F 3/04842

(57) ABSTRACT

A method for controlling a moving direction of a display object may be provided. The method includes: detecting a position of a touch input to a touch screen; determining whether the touch satisfies a scroll mode entry condition or not; setting, when the touch satisfies the scroll mode entry condition, the moving direction of the object as a direction based on the touch position; and displaying that the object moves in the moving direction, on the touch screen.

### CROSS REFERENCE TO RELATED APPLICATIONS

Priority is claimed under 35 U.S.C. §119 to Korean Patent Application No.: 10-2014-0034169, filed Mar. 24, 2014, Korean Patent Application No.: 10-2014-0048361, filed Apr. 22, 2014, Korean Patent Application No.: 10-2014-0055732, filed May 9, 2014, Korean Patent Application No.: 10-2014-0098917, filed Aug. 1, 2014, Korean Patent Application No.: 10-2014-0124920, filed Sep. 19, 2014, Korean Patent Application No.: 10-2014-0145022, filed Oct. 24, 2014, and Korean Patent Application No.: 10-2014-0186352, filed Dec. 22, 2014, the disclosures of which are incorporated herein by reference in their entireties.

### FIELD OF THE INVENTION

This embodiment relates to a method for controlling a moving direction of a display object and a terminal thereof.

### BACKGROUND OF THE INVENTION

Today, a variety of input-output devices are attached to electronic systems like a TV, a smartphone, an MP3 player, a PMP, a laptop computer, a PDA, etc. The various input-output devices are provided so as to allow a user to conveniently control the above systems. Since the smartphone, MP3 player, PMP, laptop computer, and PDA, etc., have a smaller size, there is a limit to attach the input-output devices. Therefore, a touch panel, a touch screen, a navigation pad, etc., are being increasingly attached as part of an effort to improve a user interface. Also, an integrated computer and tablet computer adopting the touch screen are distributed, so that there is a demand for various types of user interfaces.

Recently, a mouse and keyboard in a common personal computer is now being replaced with a touch screen capable of allowing the user to input data and to input commands even in a small space in various ways. Therefore, a variety of user interfaces on the touch screen are now being developed.

Though a conventional touch screen is used in various user interfaces without difficulty, the input through devices without the user interface has many limits, and thus, the user may feel inconvenient as much. For example, it is difficult to operate only by touching as accurately as the mouse and keyboard inputs, so that problems occur in games or web surfing. Specifically, in the past, the user dragged the finger, which has touched the touch screen, in a direction in which the user wants to scroll, so that an image displayed on the touch screen is scrolled. Therefore, according to the conventional scrolling method, since the user had to drag the touch, the drag direction had to be changed so as to change the scroll direction. Further, there was an inconvenience to repeatedly drag the finger in order to continuously scroll. Also, a rapid scroll requires the rapid finger drag, and a scroll at a low speed through the change of the scroll speed needs a separate slow finger drag.

### SUMMARY OF THE INVENTION

One embodiment is a method for controlling a moving direction of a display object. The method includes: detecting a position of a touch input to a touch screen; determining whether the touch satisfies a scroll mode entry condition or not; setting, when the touch satisfies the scroll mode entry condition, the moving direction of the object to be displayed on the touch screen as a direction based on the touch position; and displaying that the object moves in the moving direction, on the touch screen.

The scroll mode entry condition may be that a time period of the touch is greater than a predetermined period of time.

The setting the moving direction may set the moving direction of the object as a direction toward the center of the touch screen from the touch position.

The setting the moving direction may include determining whether or not the touch position is located within a scroll input area set in a portion of the touch screen. When the touch position is located within the scroll input area, the moving direction of the object may be set as a direction toward the center of the touch screen from the touch position.

The touch screen may be divided into a plurality of areas. The setting the moving direction may set the moving direction of the object as a direction set in the area where the touch position is located.

The setting the moving direction may include determining whether or not the touch position is located within a scroll input area set respectively in a portion of the plurality of areas. When the touch position is located within the scroll input area, the moving direction of the object may be set as a direction set in the area where the touch position is located.

The scroll input area may be disposed within an edge area of the touch screen.

The plurality of areas may include a first area and a second area located opposite to the first area with respect to the center of the touch screen. A direction set in the first area is a direction from the center of the first area to the center of the touch screen. A direction set in the second area is a direction from the center of the second area to the center of the touch screen.

When the touch satisfies the scroll mode entry condition, the scroll mode may be displayed on the touch screen.

The scroll mode may be a whole or partial touch screen of which at least one of the brightness and chroma has been changed.

The method for controlling the moving direction of the display object may further include: detecting at least any one of the magnitude of the touch pressure and touch area; and setting the moving speed of the object as a speed corresponding to at least any one of the magnitude of the touch pressure and touch area. The displaying may display that the object moves in the set moving direction and at the set speed, on the touch screen.

Another embodiment is a terminal including: a touch screen; a processor which detects a position of a touch input to the touch screen; and a controller which sets a moving direction of an object to be displayed on the touch screen as a direction based on the touch position when the touch satisfies a scroll mode entry condition.

### BRIEF DESCRIPTION OF THE DRAWINGS

FIG. 1 is a view showing a structure of a terminal according to an embodiment of the present invention;

FIGS. 2a and 2b are views for describing a capacitance change amount according to the magnitude of a touch pressure;

FIGS. 3a and 3b are views for describing the capacitance change amount according to the magnitude of a touch area;

FIGS. 4a and 4b are views for describing a touch time period;

FIG. 5 is a flowchart showing a method for controlling a moving direction of a display object according to the embodiment of the present invention;

FIGS. 6a and 6b show an example of the method for controlling the moving direction of the display object according to a first embodiment; and

FIGS. 7a to 7i show an example of a method for controlling the moving direction of the display object according to a second embodiment.

FIG. 8 is a structure view of the touch screen according to a first embodiment;

FIGS. 9a to 9d show a structure of a touch position sensing module according to the first embodiment;

FIGS. 10a to 10f show a structure of the touch pressure sensing module according to the first embodiment;

FIG. 11 is a structure view of the touch screen according to a second embodiment;

FIGS. 12a to 12k show a structure of the touch position-pressure sensing module according to the second embodiment;

FIG. 13 is a structure view of the touch screen according to a third embodiment;

FIGS. 14a to 14b show a structure of the touch position-pressure sensing module according to the third embodiment;

FIG. 15a shows a structure of the touch screen according to a fourth embodiment;

FIGS. 15b and 15c are respectively structure views of touch pressure sensing and touch position sensing of the touch screen according to the fourth embodiment; and

FIGS. 16a to 16d are structure views showing the shape of an electrode formed in the touch sensing module according to the embodiment.

### DETAILED DESCRIPTION OF THE INVENTION

The following detailed description of the present invention shows a specified embodiment of the present invention and will be provided with reference to the accompanying drawings. The embodiment will be described in enough detail that those skilled in the art are able to embody the present invention. It should be understood that various embodiments of the present invention are different from each other and need not be mutually exclusive. For example, a specific shape, structure and properties, which are described in this disclosure, may be implemented in other embodiments without departing from the spirit and scope of the present invention with respect to one embodiment. Also, it should be noted that positions or placements of individual components within each disclosed embodiment may be changed without departing from the spirit and scope of the present invention. Therefore, the following detailed description is not intended to be limited. If adequately described, the scope of the present invention is limited only by the appended claims of the present invention as well as all equivalents thereto. Similar reference numerals in the drawings designate the same or similar functions in many aspects.

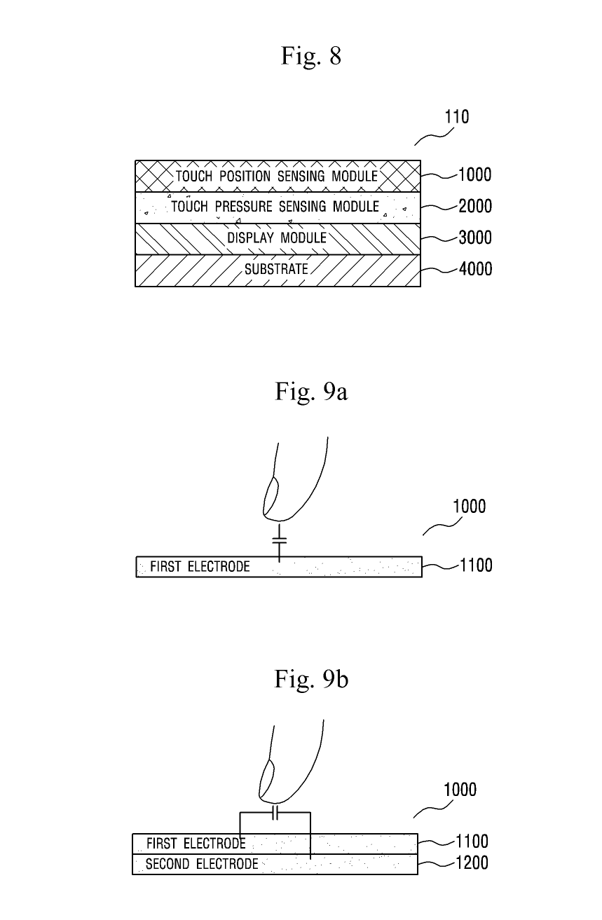

Hereafter, a method for controlling a moving direction of a display object according to an embodiment of the present invention will be described with reference to the accompanying drawings. Prior to the description of the functions and features of a terminal 100 according to the embodiment of the present invention, a touch screen 110 included in the terminal 100 will be described in detail with reference to FIGS. 8 to 16.

FIG. 8 is a structure view of the touch screen according to a first embodiment.

As shown in FIG. 8, the touch screen 110 may include a touch position sensing module 1000, a touch pressure sensing module 2000 disposed under the touch position sensing module 1000, a display module 3000 disposed under the touch pressure sensing module 2000, and a substrate 4000 disposed under the display module 3000. For example, the touch position sensing module 1000 and the touch pressure sensing module 2000 may be a transparent panel including a touch-sensitive surface. Hereafter, the modules 1000, 2000, 3000 and 5000 for sensing the touch position and/or touch pressure may be collectively designated as a touch sensing module.

The display module 3000 may display in such a manner as to allow a user to visually check contents. Here, the display module 3000 may display by means of a display driver. The display driver (not shown) is software allowing an operating system to manage or control a display adaptor and is a kind of a device driver.

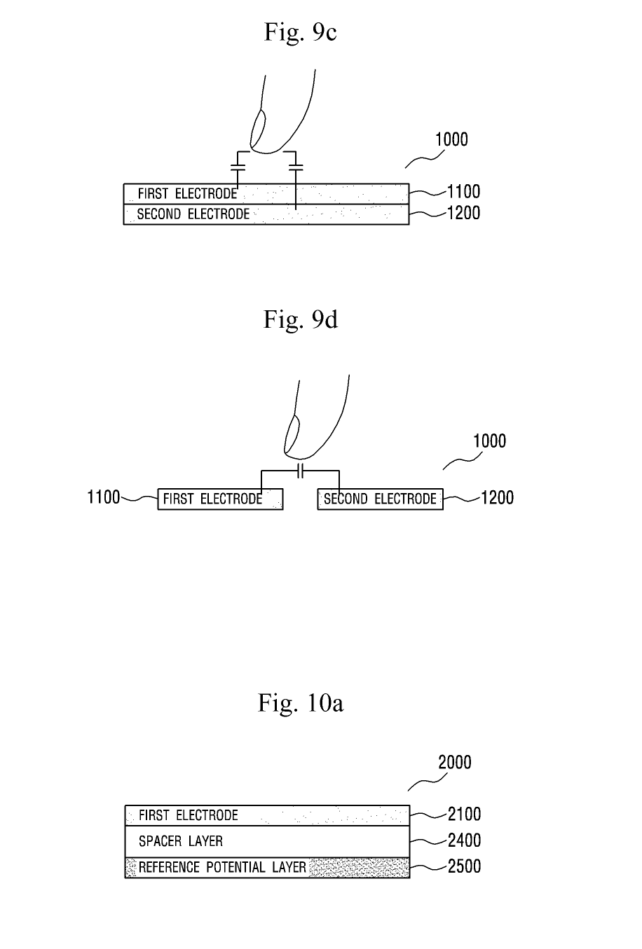

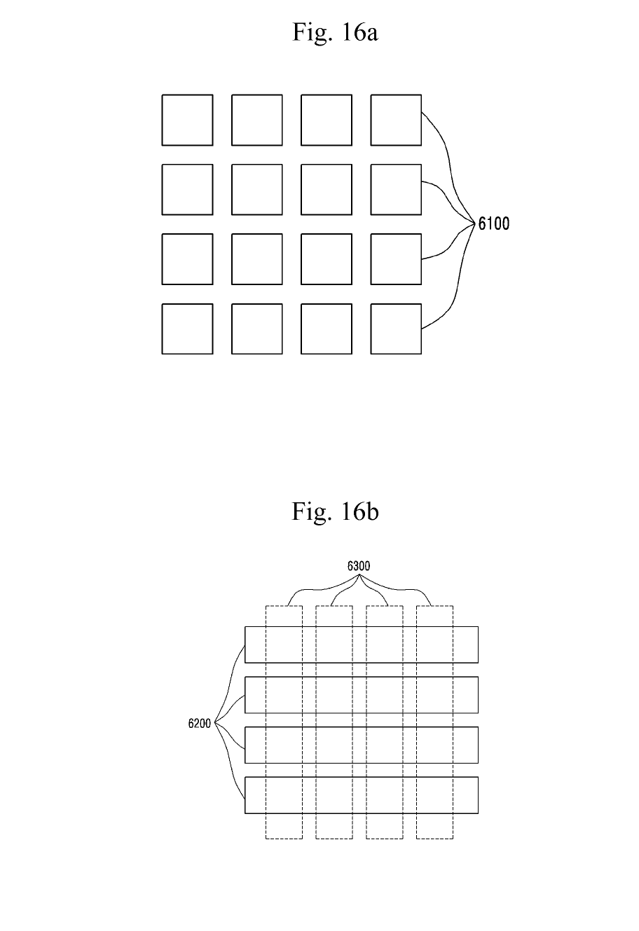

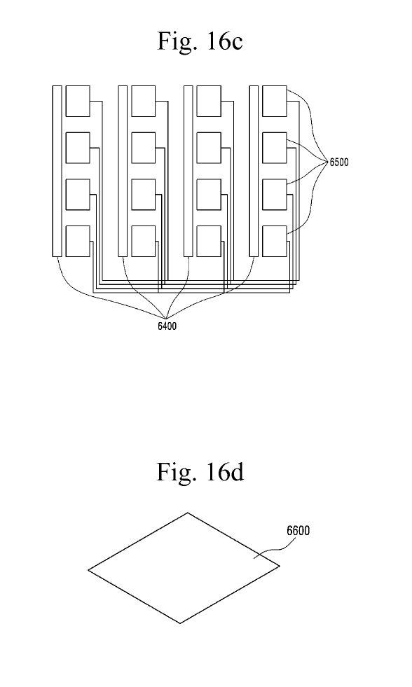

FIGS. 9a to 9d show a structure of a touch position sensing module according to the first embodiment. FIGS. 16a to 16d are structure views showing the shape of an electrode formed in the touch sensing module according to the embodiment.

As shown in FIG. 9a, the touch position sensing module 1000 according to the embodiment may include a first electrode 1100 formed in one layer. Here, the first electrode 1100 may be, as shown in FIG. 16a, comprised of a plurality of electrodes 6100, and then a driving signal may be input to each electrode 6100 and a sensing signal including information on self-capacitance may be output from each electrode. When an input means like a user's finger approaches the first electrode 1100, the finger functions as a ground and the self-capacitance of first electrode 1100 is changed. Therefore, the terminal 100 is able to detect the touch position by measuring the self-capacitance of the first electrode 1100, which is changed as the input means like the user's finger approaches the touch screen 110.

As shown in FIG. 9b, the touch position sensing module 1000 according to the embodiment may include the first electrode 1100 and a second electrode 1200, which are formed on different layers.

Here, the first and the second electrodes 1100 and 1200 are, as shown in FIG. 16b, comprised of a plurality of first electrodes 6200 and a plurality of second electrodes 6300 respectively. The plurality of first electrodes 6200 and the plurality of second electrodes 6300 may be arranged to cross each other. A driving signal may be input to any one of the first electrode 6200 and the second electrode 6300, and a sensing signal including information on mutual capacitance may be output from the other. As shown in FIG. 9b, when the input means like the user's finger approaches the first electrode 1100 and the second electrode 1200, the finger functions as a ground, so that the mutual capacitance between the first electrode 1100 and the second electrode 1200 is changed. In this case, the terminal 100 measures the mutual capacitance between the first electrode 1100 and the second electrode 1200, which is changed with the approach of the object like the user's finger to the touch screen 110, and then detects the touch position. Also, the driving signal may be input to the first electrode 6200 and the second electrode 6300, and a sensing signal including information on the self-capacitance may be output from the first and second electrodes 6200 and 6300 respectively. As shown in FIG. 9c, when the object like the user's finger approaches the first electrode 1100 and the second electrode 1200, the finger functions as a ground, so that the self-capacitance of each of the first and second electrodes 1100 and 1200 is changed. In this case, the terminal 100 measures the self-capacitances of the first electrode 1100 and the second electrode 1200, which is changed with the approach of the object like the user's finger to the touch screen 110, and then detects the touch position.

As shown in FIG. 9d, the touch position sensing module 1000 according to the embodiment may include the first electrode 1100 formed in one layer and the second electrode 1200 formed in the same layer as the layer in which the first electrode 1100 has been formed.

Here, the first and the second electrodes 1100 and 1200 are, as shown in FIG. 16c, comprised of a plurality of first electrodes 6400 and a plurality of second electrodes 6500 respectively. The plurality of first electrodes 6400 and the plurality of second electrodes 6500 may be arranged without crossing each other and may be arranged such that the plurality of second electrodes 6500 are connected to each other in a direction crossing the extension direction of the each first electrodes 6400. A principle of detecting the touch position by using the first electrode 6400 or the second electrode 6500 shown in FIG. 9d is the same as that of the foregoing referring to FIG. 9c, and thus a description of the principle will be omitted.

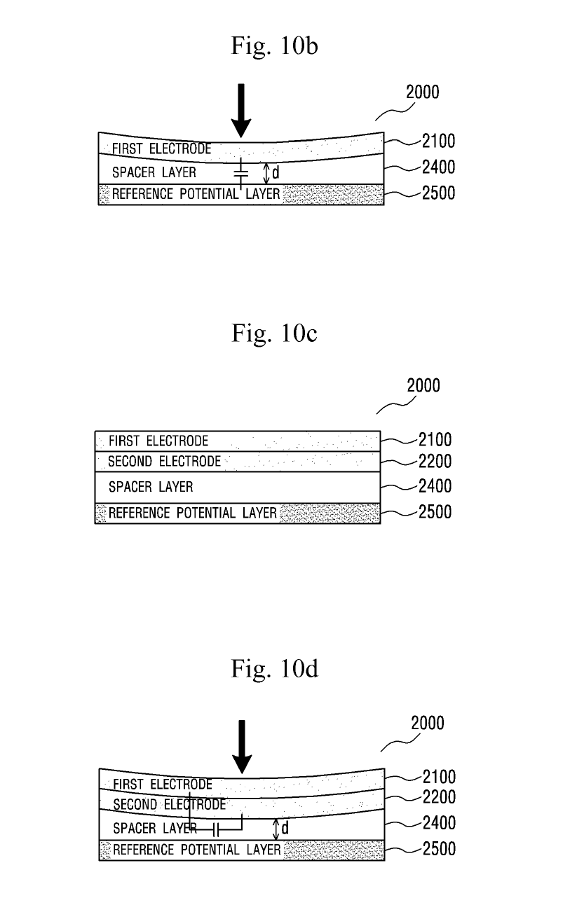

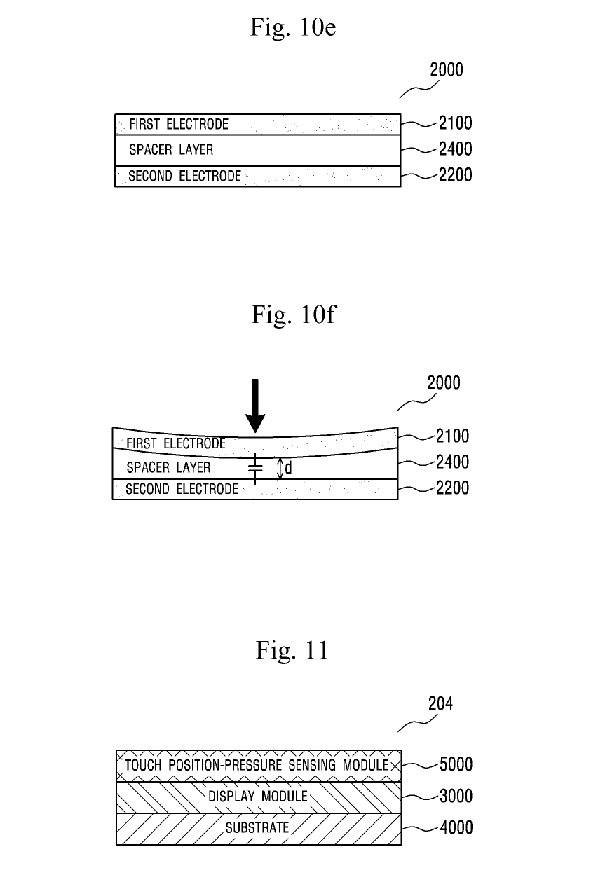

FIGS. 10a to 10f show a structure of the touch pressure sensing module according to the first embodiment. FIGS. 16a to 16d are structure views showing the shape of the electrode formed in the touch pressure sensing module 2000 according to the embodiment.

As shown in FIGS. 10a to 10f, the touch pressure sensing module 2000 according to the first embodiment may include a spacer layer 2400. The spacer layer 2400 may be implemented by an air gap. The spacer may be comprised of an impact absorbing material according to the embodiment and may be also filled with a dielectric material according to the embodiment.

As shown in FIGS. 10a to 10d, the touch pressure sensing module 2000 according to the first embodiment may include a reference potential layer 2500. The reference potential layer 2500 may have any potential. For example, the reference potential layer may be a ground layer having a ground potential. Here, the reference potential layer may include a layer which is parallel with a two-dimensional plane in which a below-described first electrode 2100 for sensing the touch pressure has been formed or a two-dimensional plane in which a below-described second electrode 2200 for sensing the touch pressure has been formed. Although it has been described in FIGS. 10a to 10d that the touch pressure sensing module 2000 includes the reference potential layer 2500, there is no limit to this. The touch pressure sensing module 2000 does not include the reference potential layer 2500, and the display module 3000 or the substrate 4000 which is disposed under the touch pressure sensing module 2000 may function as the reference potential layer.

As shown in FIG. 10a, the touch pressure sensing module 2000 according to the embodiment may include the first electrode 2100 formed in one layer, the spacer layer 2400 formed under the layer in which the first electrode 2100 has been formed, and the reference potential layer 2500 formed under the spacer layer 2400.

Here, the first electrode 2100 is, as shown in FIG. 16a, comprised of the plurality of electrodes 6100. Then, the driving signal may be input to each of the electrodes 6100 and the sensing signal including information on the self-capacitance may be output from the each electrode. When a pressure is applied to the touch screen 110 by the object like the user's finger or stylus, the first electrode 2100 is, as shown in FIG. 10b, curved at least at the touch position, so that a distance “d” between the first electrode 2100 and the reference potential layer 2500 is changed, and thus, the self-capacitance of the first electrode 2100 is changed. Accordingly, the terminal 100 is able to detect the touch pressure by measuring the self-capacitance of the first electrode 2100, which is changed by the pressure that the object like the user's finger or stylus applies to the touch screen 110. As such, since the first electrode 2100 is comprised of the plurality of electrodes 6100, the terminal 100 is able to detect the pressure of each of multiple touches which have been simultaneously input to the touch screen 110. Also, when there is no requirement for detecting the pressure of each of multiple touches, it is only required to detect overall pressure applied to the touch screen 110 irrespective of the touch position. Therefore, the first electrode 2100 of the touch pressure sensing module 2000 may be, as shown in FIG. 16d, comprised of one electrode 6600.

As shown in FIG. 10c, the touch pressure sensing module 2000 according to the embodiment may include the first electrode 2100, the second electrode 2200 formed under the layer in which the first electrode 2100 has been formed, the spacer layer 2400 formed under the layer in which the second electrode 2200 has been formed, and the reference potential layer 2500 formed under the spacer layer 2400.

Here, the first electrode 2100 and the second electrode 2200 may be configured and arranged as shown in FIG. 16b. A driving signal is input to any one of the first electrode 6200 and the second electrode 6300, and a sensing signal including information on the mutual capacitance may be output from the other. When a pressure is applied to the touch screen 110, the first electrode 2100 and the second electrode 2200 are, as shown in FIG. 10d, curved at least at the touch position, so that a distance “d” between the reference potential layer 2500 and both the first electrode 2100 and the second electrode 2200 is changed, and thus, the mutual capacitance between the first electrode 2100 and the second electrode 2200 is changed. Accordingly, the terminal 100 is able to detect the touch pressure by measuring the mutual capacitance between the first electrode 2100 and the second electrode 2200, which is changed by the pressure that is applied to the touch screen 110. As such, since the first electrode 2100 and the second electrode 2200 are comprised of the plurality of first electrodes 6200 and the plurality of second electrodes 6300 respectively, the action control system 1 is able to detect the pressure of each of multiple touches which have been simultaneously input to the touch screen 110. Also, when there is no requirement for detecting the pressure of each of multiple touches, at least one of the first electrode 2100 and the second electrode 2200 of the touch pressure sensing module 2000 may be, as shown in FIG. 16d, comprised of the one electrode 6600.

Here, even when the first electrode 2100 and the second electrode 2200 are formed in the same layer, the touch pressure can be also detected as described in FIG. 10c. The first electrode 2100 and the second electrode 2200 may be configured and arranged as shown in FIG. 16c, or may be comprised of the one electrode 6600 as shown in FIG. 16d.

As shown in FIG. 10e, the touch pressure sensing module 2000 according to the embodiment may include the first electrode 2100 formed in one layer, the spacer layer 2400 formed under the layer in which the first electrode 2100 has been formed, and the second electrode 2200 formed under the spacer layer 2400.

In FIG. 10e, the configuration and operation of the first electrode 2100 and the second electrode 2200 are the same as those of the foregoing referring to FIG. 10c, and thus, a description of the configuration and operation will be omitted. When a pressure is applied to the touch screen 110, the first electrode 2100 is, as shown in FIG. 10f, curved at least at the touch position, so that a distance “d” between the first electrode 2100 and the second electrode 2200 is changed, and thus, the mutual capacitance between the first electrode 2100 and the second electrode 2200 is changed. Accordingly, the terminal 100 is able to detect the touch pressure by measuring the mutual capacitance between the first electrode 2100 and the second electrode 2200.

As shown in FIG. 11, a touch screen 110 according to a second embodiment may include a touch position-pressure sensing module 5000, a display module 3000 disposed under the touch position-pressure sensing module 5000, and a substrate 4000 disposed under the display module 3000.

Unlike the embodiment shown in FIG. 8, the touch position-pressure sensing module 5000 according to the embodiment shown in FIG. 11 includes at least one electrode for sensing the touch position, and at least one electrode for sensing the touch pressure. At least one of the electrodes is used to sense both the touch position and the touch pressure. As such, the electrode for sensing the touch position and the electrode for sensing the touch pressure are shared, so that it is possible to reduce the manufacturing cost of the touch position-pressure sensing module, to reduce the overall thickness of the touch screen 110 and to simplify the manufacturing process. In the sharing of the electrode for sensing the touch position and the electrode for sensing the touch pressure, when it is necessary to distinguish between the sensing signal including information on the touch position and the sensing signal including information on the touch pressure, it is possible to distinguish and sense the touch position and the touch pressure by differentiating a frequency of the driving signal for sensing the touch position from a frequency of the driving signal for sensing the touch pressure, or by differentiating a time interval for sensing the touch position from a time interval for sensing the touch pressure.

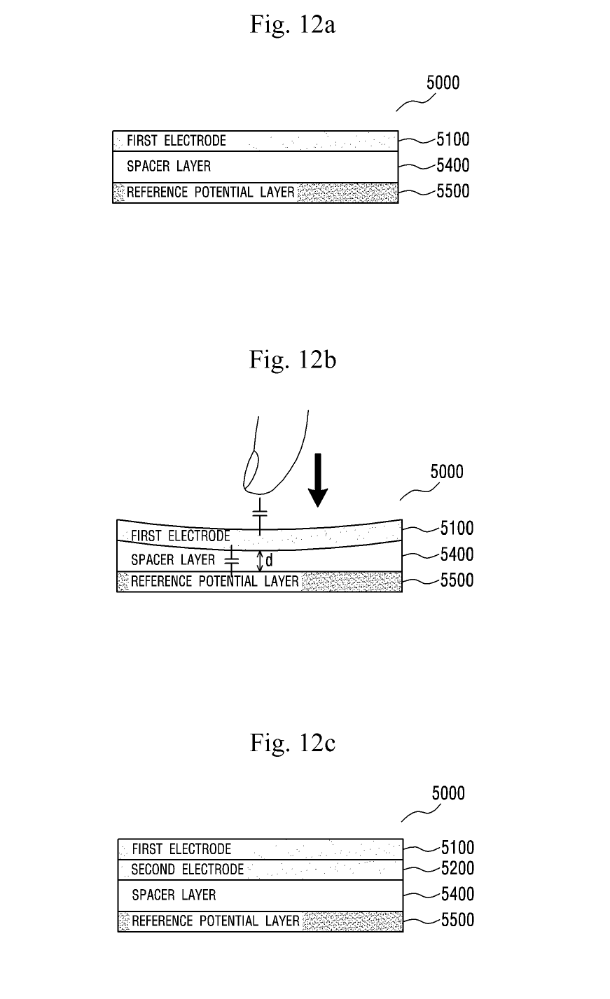

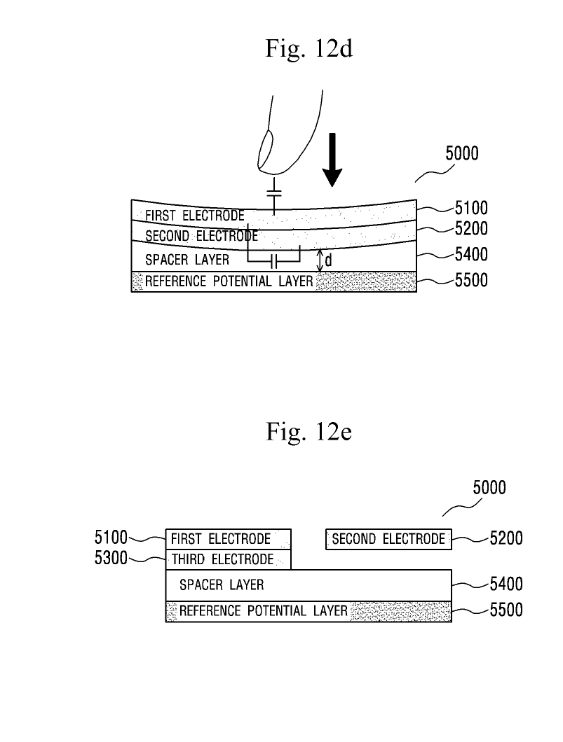

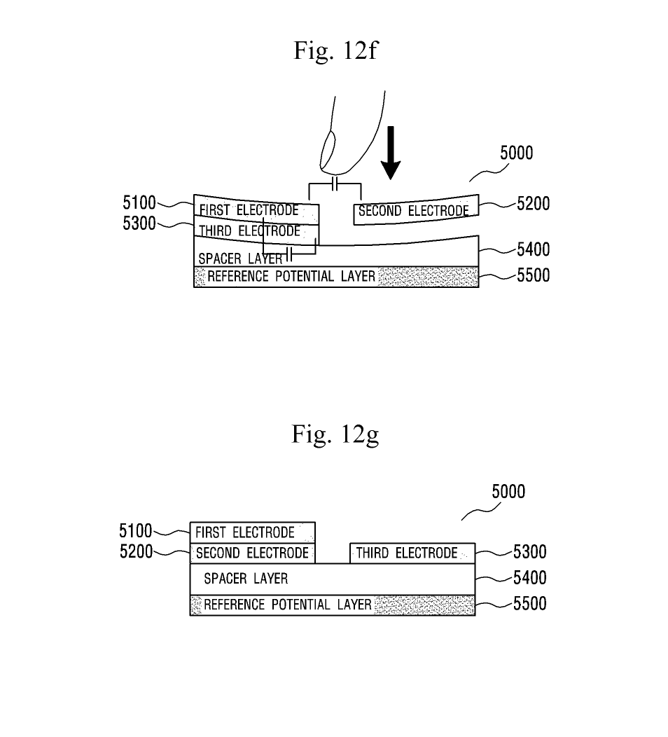

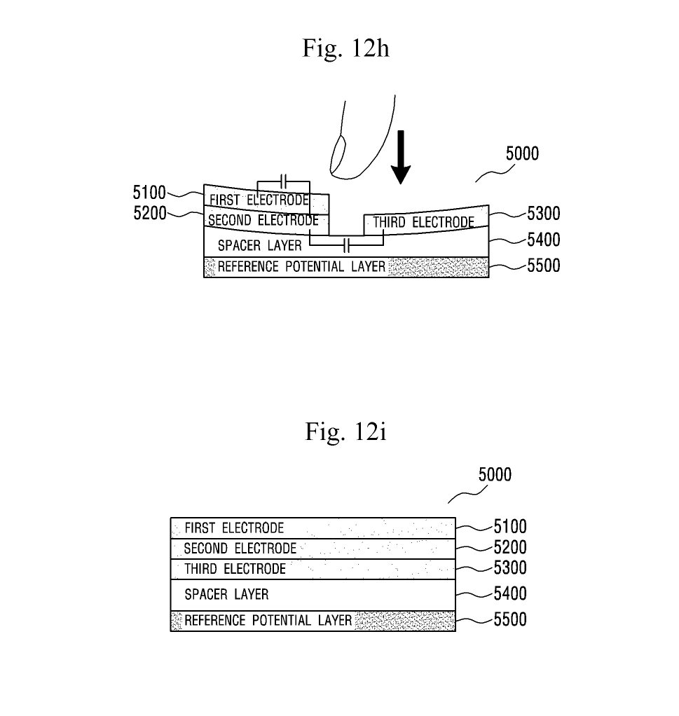

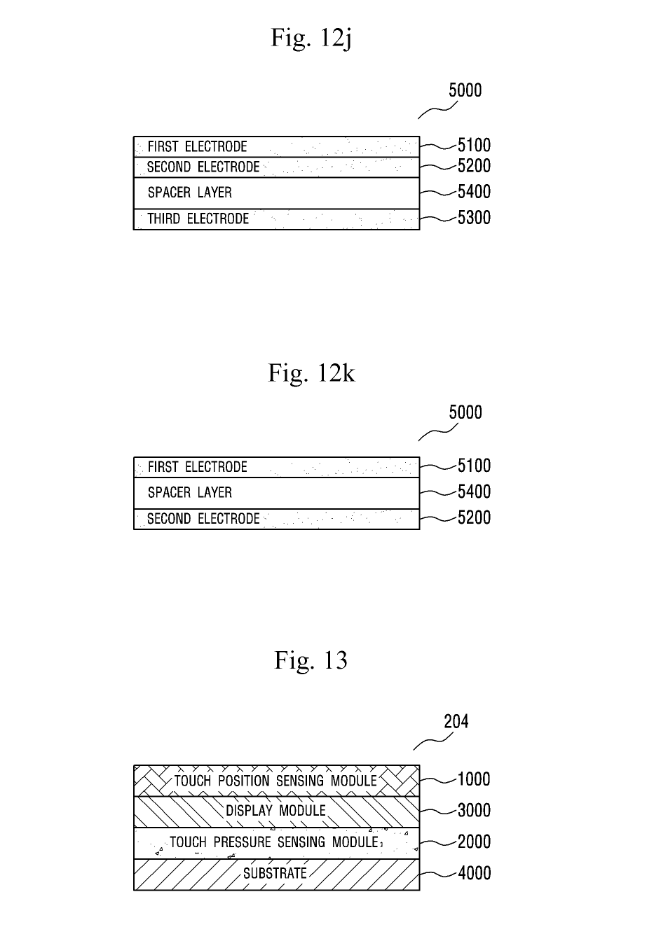

FIGS. 12a to 12k show a structure of the touch position-pressure sensing module according to the second embodiment. As shown in FIGS. 12a to 12k, the touch position-pressure sensing module 5000 according to the second embodiment may include a spacer layer 5400.

As shown in FIGS. 12a to 12i, the touch position-pressure sensing module 5000 according to the embodiment may include a reference potential layer 5500. The reference potential layer 5500 is the same as that of the foregoing referring to FIGS. 10a to 10d, and thus, a description of the reference potential layer 5500 will be omitted. The reference potential layer may include a layer which is parallel with a two-dimensional plane in which a below-described first electrode 5100 for sensing the touch pressure has been formed, a two-dimensional plane in which a below-described second electrode 5200 for sensing the touch pressure has been formed, or a two-dimensional plane in which a below-described third electrode 5300 for sensing the touch pressure has been formed.

As shown in FIG. 12a, the touch position-pressure sensing module 5000 according to the embodiment may include the first electrode 5100 formed in one layer, the spacer layer 5400 formed under the layer in which the first electrode 5100 has been formed, and the reference potential layer 5500 formed under the spacer layer 5400.

A description of the configuration of FIGS. 12a and 12b is similar to the description referring to FIGS. 10a and 10b. Hereafter, only the difference between them will be described. As shown in FIG. 12b, when the object like the user's finger approaches the first electrode 5100, the finger functions as a ground and the touch position can be detected by the change of the self-capacitance of the first electrode 5100. Also, when a pressure is applied to the touch screen 110 by the object, a distance “d” between the first electrode 5100 and the reference potential layer 5500 is changed, and thus, the touch pressure can be detected by the change of the self-capacitance of the first electrode 5100.

As shown in FIG. 12c, the touch position-pressure sensing module 5000 according to the embodiment may include the first electrode 5100 formed in one layer, the second electrode 5200 formed in a layer under the layer in which the first electrode 5100 has been formed, the spacer layer 5400 formed under the layer in which the second electrode 5200 has been formed, and the reference potential layer 5500 formed under the spacer layer 5400.

A description of the configuration of FIGS. 12c to 12f is similar to the description referring to FIGS. 10c and 10d. Hereafter, only the difference between them will be described. Here, the first electrode 5100 and the second electrode 5200 may be, as shown in FIG. 16a, comprised of the plurality of electrodes 6100 respectively. As shown in FIG. 12d, when the object like the user's finger approaches the first electrode 5100, the finger functions as a ground and the touch position can be detected by the change of the self-capacitance of the first electrode 5100. Also, when a pressure is applied to the touch screen 110 by the object, a distance “d” between the reference potential layer 5500 and both the first electrode 5100 and the second electrode 5200 is changed, and thus, the touch pressure can be detected by the change of the mutual capacitance between the first electrode 5100 and the second electrode 5200.

Also, according to the embodiment, each of the first and second electrodes 5100 and 5200 may be, as shown in FIG. 16b, comprised of the plurality of first electrodes 6200 and the plurality of second electrodes 6300. The plurality of first electrodes 6200 and the plurality of second electrodes 6300 may be arranged to cross each other. Here, the touch position can be detected by the change of the mutual capacitance between the first electrode 5100 and the second electrode 5200, and the touch pressure can be detected by the change of the self-capacitance of the second electrode 5200 according to the change of a distance “d” between the second electrode 5200 and the reference potential layer 5500. Also, according to the embodiment, the touch position can be detected by the change of the mutual capacitance between the first electrode 5100 and the second electrode 5200, and also, the touch pressure can be detected by the change of the mutual capacitance between the first electrode 5100 and the second electrode 5200 according to the change of the distance “d” between the reference potential layer 5500 and both the first electrode 5100 and the second electrode 5200.

Here, even when the first electrode 5100 and the second electrode 5200 are formed in the same layer, the touch position and touch pressure can be also detected as described with reference to FIGS. 12c and 12d. However, in FIGS. 12c and 12d, regarding the embodiment where the electrode should be configured as shown in FIG. 16b, when the first electrode 5100 and the second electrode 5200 are formed in the same layer, the first electrode 5100 and the second electrode 5200 may be configured as shown in FIG. 16c.

As shown in FIG. 12e, the touch position-pressure sensing module 5000 according to the embodiment may include the first electrode 5100 and the second electrode 5200 which have been in the same layer, the third electrode 5300 which has been formed in a layer under the layer in which the first electrode 5100 and the second electrode 5200 have been formed, the spacer layer 5400 formed under the layer in which the third electrode 5300 has been formed, and the reference potential layer 5500 formed under the spacer layer 5400.

Here, the first electrode 5100 and the second electrode 5200 may be configured and arranged as shown in FIG. 16c, and the first electrode 5100 and the third electrode 5300 may be configured and arranged as shown in FIG. 16b. As shown in FIG. 12f, when the object like the user's finger approaches the first electrode 5100 and the second electrode 5200, the mutual capacitance between the first electrode 5100 and the second electrode 5200 is changed, so that the touch position can be detected. When a pressure is applied to the touch screen 110 by the object, a distance “d” between the reference potential layer 5500 and both the first electrode 5100 and the third electrode 5300 is changed, and then the mutual capacitance between the first electrode 5100 and the third electrode 5300 is hereby changed, so that the touch pressure can be detected. Also, according to the embodiment, the touch position can be detected by the change of the mutual capacitance between the first electrode 5100 and the third electrode 5300, and the touch pressure can be detected by the change of the mutual capacitance between the first electrode 5100 and the second electrode 5200.

As shown in FIG. 12g, the touch position-pressure sensing module 5000 according to the embodiment may include the first electrode 5100 formed in one layer, the second electrode 5200 formed in a layer under the layer in which the first electrode 5100 has been formed, the third electrode 5300 formed in the same layer as the layer in which the second electrode 5200 has been formed, the spacer layer 5400 formed under the layer in which the second electrode 5200 and the third electrode 5300 have been formed, and the reference potential layer 5500 formed under the spacer layer 5400.

Here, the first electrode 5100 and the second electrode 5200 may be configured and arranged as shown in FIG. 16b, and the second electrode 5200 and the third electrode 5300 may be configured and arranged as shown in FIG. 16c. In FIG. 12h, the touch position can be detected by the change of the mutual capacitance between the first electrode 5100 and the second electrode 5200, and the touch pressure can be detected by the change of the mutual capacitance between the second electrode 5200 and the third electrode 5300. Also, according to the embodiment, the touch position can be detected by the change of the mutual capacitance between the first electrode 5100 and the third electrode 5300, and the touch pressure can be detected by the change of the mutual capacitance between the first electrode 5100 and the second electrode 5200.

As shown in FIG. 12i, the touch position-pressure sensing module 5000 according to the embodiment may include the first electrode 5100 formed in one layer, the second electrode 5200 formed in a layer under the layer in which the first electrode 5100 has been formed, the third electrode 5300 formed under the layer in which the second electrode 5200 has been formed, the spacer layer 5400 formed under the layer in which the third electrode 5300 has been formed, and the reference potential layer 5500 formed under the spacer layer 5400.

Here, the first electrode 5100 and the second electrode 5200 may be configured and arranged as shown in FIG. 16b, and the second electrode 5200 and the third electrode 5300 may be also configured and arranged as shown in FIG. 16b. Here, when the object like the user's finger approaches the first electrode 5100 and the second electrode 5200, the finger functions as a ground and the touch position can be detected by the change of the mutual capacitance between the first electrode 5100 and the second electrode 5200. Also, when a pressure is applied to the touch screen 110 by the object, a distance “d” between the reference potential layer 5500 and both the second electrode 5200 and the third electrode 5300 is changed, so that the touch pressure can be detected by the change of the mutual capacitance between the second electrode 5200 and the third electrode 5300. Also, according to the embodiment, when the object like the user's finger approaches the first electrode 5100 and the second electrode 5200, the finger functions as a ground, so that the touch position can be detected by the change of the self-capacitance of each of the first and second electrodes 5100 and 5200.

As shown in FIG. 12j, the touch position-pressure sensing module 5000 according to the embodiment may include the first electrode 5100 formed in one layer, the second electrode 5200 formed in a layer under the layer in which the first electrode 5100 has been formed, the spacer layer 5400 formed under the layer in which the second electrode 5200 has been formed, and the third electrode 5300 formed under the spacer layer 5400.

Here, the first electrode 5100 and the second electrode 5200 may be configured and arranged as shown in FIG. 16b, and the third electrode 5300 may be configured as shown in FIG. 16a or the second electrode 5200 and the third electrode 5300 may be also configured and arranged as shown in FIG. 16b. Here, when the object like the user's finger approaches the first electrode 5100 and the second electrode 5200, the finger functions as a ground and the touch position can be detected by the change of the mutual capacitance between the first electrode 5100 and the second electrode 5200. Also, when a pressure is applied to the touch screen 110 by the object, a distance “d” between the second electrode 5200 and the third electrode 5300 is changed, so that the touch pressure can be detected by the change of the mutual capacitance between the second electrode 5200 and the third electrode 5300. Also, according to the embodiment, when the object like the user's finger approaches the first electrode 5100 and the second electrode 5200, the finger functions as a ground, so that the touch position can be detected by the change of the self-capacitance of each of the first and second electrodes 5100 and 5200.

As shown in FIG. 12k, the touch position-pressure sensing module 5000 according to the embodiment may include the first electrode 5100 formed in one layer, the spacer layer 5400 formed under the layer in which the first electrode 5100 has been formed, and the second electrode 5200 formed under the spacer layer 5400.

Here, the first electrode 5100 and the second electrode 5200 may be configured and arranged as shown in FIG. 16b. Here, the touch position can be detected by the change of the mutual capacitance between the first electrode 5100 and the second electrode 5200. Also, when a pressure is applied to the touch screen 110 by the object, a distance “d” between the first electrode 5100 and the second electrode 5200 is changed, so that the touch pressure can be detected by the change of the mutual capacitance between the first electrode 5100 and the second electrode 5200. The first electrode 5100 and the second electrode 5200 may be configured and arranged as shown in FIG. 16a. Here, when the object like the user's finger approaches the first electrode 5100, the finger functions as a ground and the self-capacitance of the first electrode 5100 is changed, so that the touch position can be detected. Also, the touch pressure can be detected by the change of the mutual capacitance between the first electrode 5100 and the second electrode 5200.

As shown in FIG. 13, a touch screen 110 according to a third embodiment may include the touch position sensing module 1000, the display module 3000 disposed under the touch position sensing module 1000, the touch pressure sensing module 2000 disposed under the display module 3000, and the substrate 4000 disposed under the touch pressure sensing module 2000.

In the touch screens 110 according to the embodiment shown in FIGS. 8 and 11, since the touch pressure sensing module 2000 which includes the spacer layer 2400 or the touch position-pressure sensing module 5000 which includes the spacer layer 5400 is disposed on the display module 3000, the color clarity, visibility, optical transmittance of the display module 3000 may be reduced. Therefore, in order to prevent such problems, the touch position sensing module 1000 and the display module 3000 are fully laminated by using an adhesive like an optically clear adhesive (OCA), and the touch pressure sensing module 2000 is disposed under the display module 3000. As a result, the aforementioned problem can be alleviated and solved. Also, an existing gap formed between the display module 3000 and the substrate 4000 is used as the spacer layer for detecting the touch pressure, so that the overall thickness of the touch screen 110 can be reduced.

The touch position sensing module 1000 according to the embodiment shown in FIG. 13 is the same as the touch position sensing module shown in FIGS. 9a to 9d.

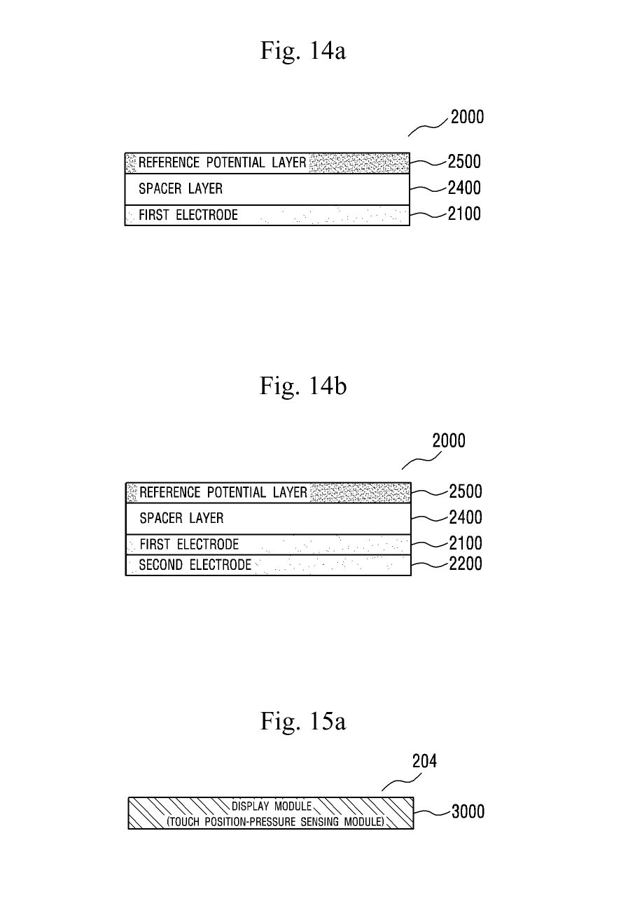

The touch pressure sensing module 2000 according to the embodiment shown in FIG. 13 may be the touch pressure sensing module shown in FIGS. 10a to 10f and the touch pressure sensing module shown in FIGS. 14a to 14b.

As shown in FIG. 14a, the touch pressure sensing module 2000 according to the embodiment may include the reference potential layer 2500, the spacer layer 2400 formed under the reference potential layer 2500, and the first electrode 2100 formed under the spacer layer 2400. Since the configuration and operation of FIG. 14a are the same as those of FIGS. 10a and 10b with the exception of the fact that the position of the reference potential layer 2500 and the position of the first electrode 2100 are replaced with each other, repetitive descriptions thereof will be omitted hereafter.

As shown in FIG. 14b, the touch pressure sensing module 2000 according to the embodiment may include the reference potential layer 2500, the spacer layer 2400 formed under the ground, the first electrode 2100 formed in a layer under the spacer layer 2400, and the second electrode 2200 formed in a layer under the layer in which the first electrode 2100 has been formed. Since the configuration and operation of FIG. 14b are the same as those of FIGS. 10c and 10d with the exception of the fact that the position of the reference potential layer 2500, the position of the first electrode 2100 and the position of the second electrode 2200 are replaced with each other, repetitive descriptions thereof will be omitted hereafter. Here, even when the first electrode 2100 and the second electrode 2200 are formed in the same layer, the touch pressure can be detected as described in FIGS. 10c and 10d.

Although it has been described in FIG. 13 that the display module 3000 is disposed under the touch position sensing module 1000, the touch position sensing module 1000 can be included within the display module 3000. Also, although it has been described in FIG. 13 that the touch pressure sensing module 2000 is disposed under the display module 3000, a portion of the touch pressure sensing module 2000 can be included within the display module 3000. Specifically, the reference potential layer 2500 of the touch pressure sensing module 2000 may be disposed within the display module 3000, and the electrodes 2100 and 2200 may be formed under the display module 3000. As such, when the reference potential layer 2500 is disposed within the display module 3000, a gap formed within the display module 3000 is used as the spacer layer for detecting the touch pressure, so that the overall thickness of the touch screen 110 can be reduced. Here, the electrodes 2100 and 2200 may be formed on the substrate 4000. As such, when the electrodes 2100 and 2200 are formed on the substrate 4000, not only the gap formed within the display module 3000 but also the gap formed between the display module 3000 and the substrate 4000 is used as the spacer layer for detecting the touch pressure, so that the sensitivity for detecting the touch pressure can be more improved.

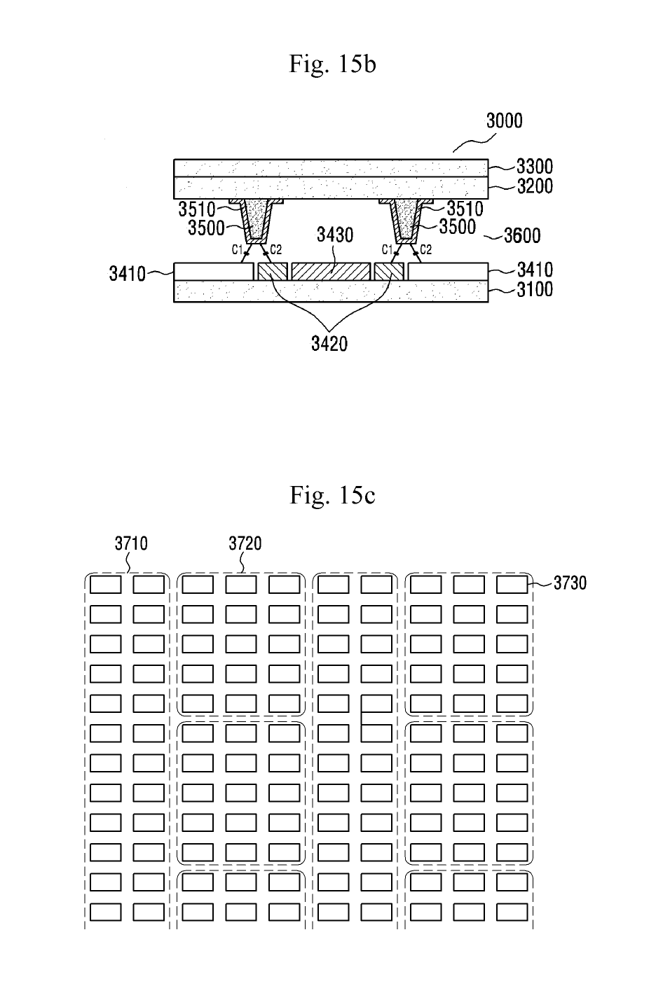

FIG. 15a shows a structure of the touch screen according to a fourth embodiment. As shown in FIG. 15a, the touch screen 110 according to the fourth embodiment may include at least one of the touch position sensing module and the touch pressure sensing module within the display module 3000.

FIGS. 15b and 15c are structure views of touch pressure sensing and touch position sensing of the touch screen according to the fourth embodiment. FIGS. 15b and 15c take an LCD panel as an example of the display module 3000.

In case of the LCD panel, the display module 3000 may include a TFT layer 3100 and a color filter layer 3300. The TFT layer 3100 includes a TFT substrate layer 3110 disposed directly thereon. The color filter layer 3300 includes a color filter substrate layer 3200 disposed directly thereunder. The display module 3000 includes a liquid crystal layer 3600 between the TFT layer 3100 and the color filter layer 3300. Here, the TFT substrate layer 3110 includes electrical components necessary to generate an electric field driving the liquid crystal layer 3600. Particularly, the TFT substrate layer 3110 may be comprised of various layers including a data line, a gate line, TFT, a common electrode, a pixel electrode and the like. These electrical components generate a controlled electric field and orient the liquid crystals in the liquid crystal layer 3600. More specifically, The TFT substrate layer 3110 may include a column common electrode (column Vcom) 3430, a low common electrode (low Vcom) 3410, and a guard shield electrode 3420. The guard shield electrode 3420 is located between the column common electrode 3430 and the low common electrode 3410 and is able to minimize the interference caused by a fringe field which may be generated between the column common electrode 3430 and the low common electrode 3410. The foregoing description of the LCD panel is apparent to those skilled in the art.

As shown in FIG. 15b, the display module 3000 according to the embodiment of the present invention may include sub-photo spacers 3500 disposed on the color filter substrate layer 3200. These sub-photo spacers 3500 may be disposed on the interface between the low common electrode 3410 and the adjacent guard shield electrode 3420. Here, a conductive material layer 3510 like ITO may be patterned on the sub-photo spacer 3500. Here, a fringing capacitance C1 is formed between the low common electrode 3410 and the conductive material layer 3510, and a fringing capacitance C2 is formed between the guard shield electrode 3420 and the conductive material layer 3510.

When the display module 3000 shown in FIG. 15b functions as the touch pressure sensing module, a distance between the sub-photo spacers 3500 and the TFT substrate layer 3110 may be reduced by an external pressure, and thus, a capacitance between the low common electrode 3410 and the guard shield electrode 3420 may be reduced. Accordingly, in FIG. 15b, the conductive material layer 3510 functions as the reference potential layer and detects the change of the capacitance between the low common electrode 3410 and the guard shield electrode 3420, so that the touch pressure can be detected.

FIG. 15c shows a structure in which the LCD panel as the display module 3000 is used as the touch position sensing module. The arrangement of the common electrodes 3730 is shown in FIG. 15c. Here, for the purpose of detecting the touch position, these common electrodes 3730 may be divided into a first area 3710 and a second area 3720. Accordingly, for example, the common electrodes 3730 included in one first area 3710 may be operated in such a manner as to function in response to the first electrode 6400 of FIG. 16c, and the common electrodes 3730 included in one second area 3720 may be operated in such a manner as to function in response to the second electrode 6500 of FIG. 16c. That is, in order that the common electrodes 3730, i.e., electrical components for driving the LCD panel are used to detect the touch position, the common electrodes 3730 may be grouped. Such a grouping can be accomplished by a structural configuration and manipulation of operation.

As described above, in FIG. 15, the electrical components of the display module 3000 are caused to operate in conformity with their original purpose, so that the display module 3000 performs its own function. Also, at least some of the electrical components of the display module 3000 are caused to operate for detecting the touch pressure, so that the display module 3000 functions as the touch pressure sensing module. Also, at least some of the electrical components of the display module 3000 are caused to operate for detecting the touch position, so that the display module 3000 functions as the touch position sensing module. Here, each operation mode may be performed in a time-division manner. In other words, the display module 3000 may function as the display module in a first time interval, as the pressure sensing module in a second time interval, and/or as the position sensing module in a third time interval.

FIGS. 15b and 15c only show the structures for the detection of the touch pressure and the touch position respectively for convenience of description. So long as the display module 3000 can be used to detect the touch pressure and/or the touch position by operating the electrical components for the display operation of the display module 3000, the display module 3000 can be included in the fourth embodiment.

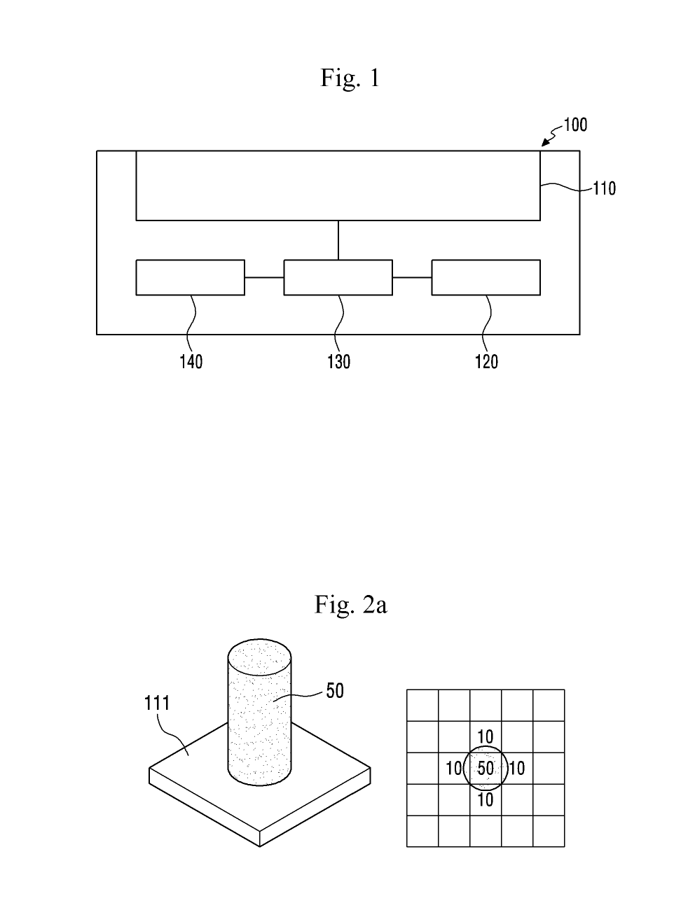

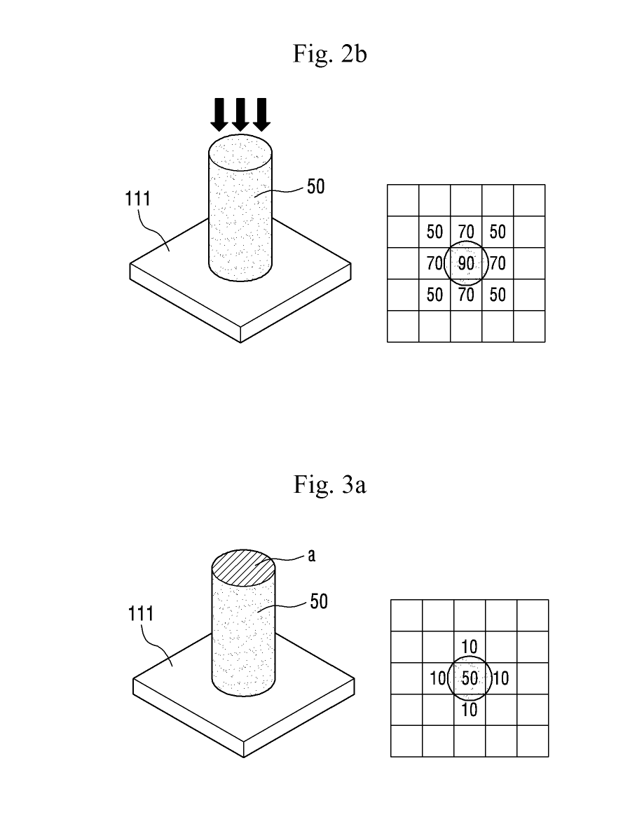

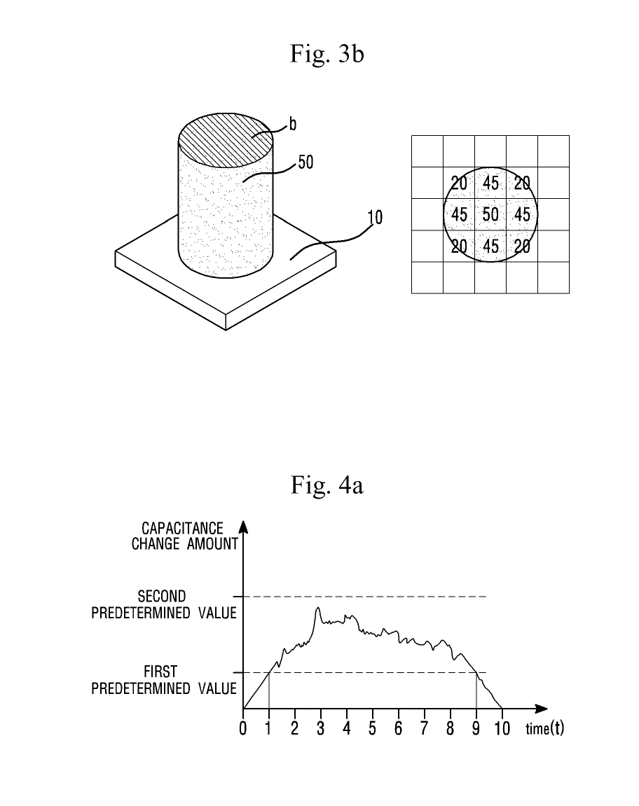

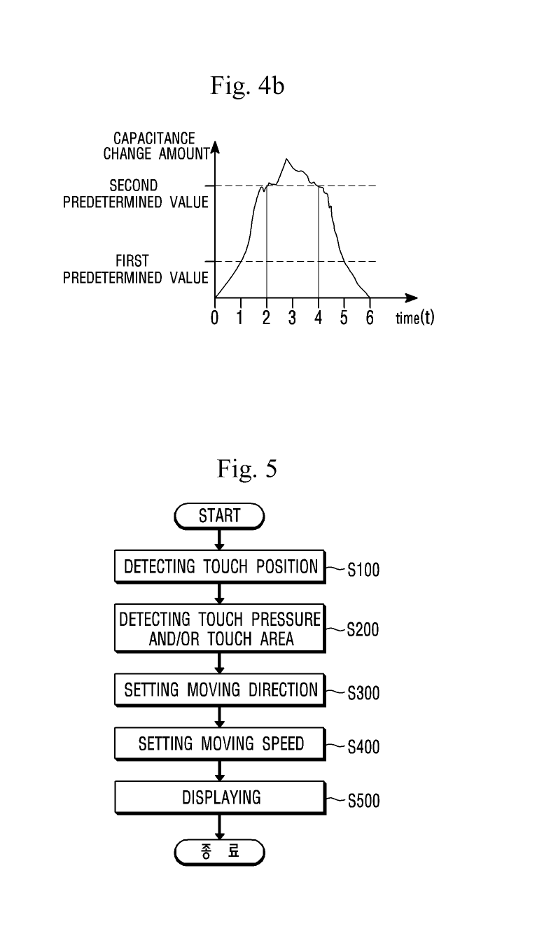

FIG. 1 is a view showing a structure of a terminal according to an embodiment of the present invention. FIGS. 2a and 2b are views for describing a capacitance change amount according to the magnitude of the touch pressure. FIGS. 3a and 3b are views for describing the capacitance change amount according to the magnitude of a touch area. FIGS. 4a and 4b are views for describing a touch time period.

FIG. 1 is a view showing a structure of a terminal according to an embodiment of the present invention. The terminal 100 may include the touch screen 110 and a processor 120.

The terminal 100 according to the embodiment of the present invention includes the touch screen 110 and is a computing device capable of performing the input to the terminal 100 through the touch on the touch screen 110. The terminal 100 according to the embodiment of the present invention may be a portable electronic device like a laptop computer, a personal digital assistant (PDA), and a smartphone. Also, the terminal 100 according to the embodiment of the present invention may be a non-portable electronic device like a desktop computer and a smart television.

The touch screen 110 according to the embodiment of the present invention allows the user to operate a computing system by touching the screen by the object, i.e., a finger, etc. In general, the touch screen 110 recognizes the touch on the panel, and then the computing system analyzes the touch and performs operations in accordance with the analysis.

When the touch is input to the touch screen 110, the processor 120 according to the embodiment of the present invention may detect whether the touch occurs on the touch screen 110 or not and the touch position (or coordinates). Also, when the touch is input to the touch screen 110, the processor 120 according to the embodiment of the present invention may measure the capacitance change amount occurring according to the touch.

For example, the size of the mutual capacitance change amount may be changed according to the magnitude of the touch pressure and/or touch area at the time of touching the touch screen. Therefore, when the touch is input to the touch screen 110, the processor 120 may measure the size of the mutual capacitance change amount according to the magnitude of the touch pressure and/or touch area. Here, the less the magnitude of the touch pressure is, the less the capacitance change amount is, and the greater the magnitude of the touch pressure is, the more the capacitance change amount is. Also, the less the touch area is, the more the capacitance change amount is.

Specifically, the capacitance change amount caused by the object 50 touching the touch screen 110 may be measured by summing the capacitance change amounts of a plurality of sensing cells. For example, as shown in FIG. 2a, when the object 50 touches the touch screen 110 without pressure (simple touch), the sum of the capacitance change amounts is 90 (=50+10+10+10+10). Also, as shown in FIG. 2b, when the object 50 touches the touch screen 110 at a predetermined pressure, the sum of the capacitance change amounts may be 570 (=90+70+70+70+70+50+50+50+50).

Also, as shown in FIG. 3a, when the area of the object 50 touching the touch screen 110 is “a”, the sum of the capacitance change amounts is 90 (=50+10+10+10+10). Here, as shown in FIG. 3b, when the area of the object 50 touching the touch screen 110 becomes greater from “a” to “b” (b>a), the sum of the capacitance change amounts is increased to 310 (=50+45+45+45+45+20+20+20+20).

Particularly, the processor 120 according to the embodiment of the present invention is able to recognize a hovering state in which the object like the finger does not touch directly the touch screen 110 and is close enough to the touch screen 204 to cause the change of the capacitance in the touch screen 110.

For example, when the object is located within approximately 2 cm from the surface of the touch screen 110, the processor 120 is able to detect whether or not the object exists and the location of the object through the capacitance change. Here, in order to prevent the meaningless movement of the object from being recognized as the hovering, the movement of the object, which satisfies a predetermined condition, can be recognized as the hovering.

For instance, when the object is maintained within a predetermined distance from the touch screen 110 for a time period longer than a predetermined time period from a stationary state, the existence of the object may be recognized as the hovering. Here, the fact that “the object is in the stationary state with respect to the touch screen 110” may mean that the relative two-dimensional movement with respect to the two-dimensional surface of the touch screen 110 is within a predetermined range. Here, the error in the movement may be set variously according to the embodiment. Likewise, a predetermined time period for which the object is in the stationary state may be also set variously according to the embodiment. In order that the movement of the object is recognized as the hovering over the touch screen 110, it is preferable that the capacitance change amount occurring in the touch screen 110 by the hovering is greater than the capacitance error occurring in the common touch screen 110.

The size of the mutual capacitance change amount in the touch screen 110, which is generated during the hovering of the object, may be smaller than that of the capacitance change amount of the direct touch on the touch screen 110. Hereafter, in the method for controlling the moving direction of the display object in accordance with the magnitude of the pressure of the touch on the touch screen 110, the touch may include the hovering. For instance, the hovering may be classified as having the smallest magnitude of the touch pressure and/or touch area.

Therefore, the processor 120 detects the capacitance change amount occurring in the touch screen 110 and then may determine whether or not the touch which can be recognized as the touch or hovering occurs, and measure the position of the touch and the capacitance change amount of the touch.

The terminal 100 may further include a controller 130 and a memory 140 according to the embodiment of the present invention.

The controller 130 may calculate the touch time period by using the capacitance change amount transmitted from the processor 140.

Specifically, when the touch on the touch screen 110 is the hovering, the controller 130 measures a time period for which the capacitance change amount is maintained greater than a first predetermined value and less than a second predetermined value, thereby calculating a time period for which the object has touched the touch screen 110. Here, the first predetermined value may be the minimum value of the capacitance change amount, which allows the touch to be recognized as the hovering, and the second predetermined value may be the maximum value of the capacitance change amount, which allows the touch to be recognized as the hovering. For example, when the first predetermined value is 20 and the second predetermined value is 50, a time period for which the capacitance change amount is maintained greater than 20 and less than 50 is, as shown in FIG. 4a, 8t, so that the touch time period by the hovering is 8t.

Also, when the touch on the touch screen 110 is the direct touch, the controller 130 measures a time period for which the capacitance change amount is maintained greater than and not equal to the second predetermined value, thereby calculating a time period for which the object has touched the touch screen 110. For example, when the second predetermined value is 50, the time period for which the capacitance change amount is maintained greater than and not equal to 50 is, as shown in FIG. 4b, 2t, so that the touch time period by the direct touch is 2t.

The controller 130 may set the moving direction of the object to be displayed on the touch screen 110 by using the touch position transmitted from the processor 120.

The controller 130 may determine a level of the touch on the touch screen 110 according to the capacitance change amount transmitted from the processor 120.

Specifically, the controller 130 may determine a stepwise touch level and/or non-stepwise touch level in accordance with at least one of the magnitude of the touch pressure and/or touch area.

First, the stepwise touch level will be described. The controller 130 may calculate the stepwise touch level in accordance with the size range of the capacitance change amount according to the at least one of the magnitude of the touch pressure and touch area. For example, when the capacitance change amount is assumed to have a value of from 0 to 400, the touch level may be calculated as a first level for the capacitance change amount which has a value within a range with the smallest value from 0 to 400, may be calculated as a second level for the capacitance change amount which has a value within a range with the next largest value from 100 and 200, may be calculated as a third level for the capacitance change amount which has a value within a range with the next largest value from 200 and 300, and may be calculated as a fourth level for the capacitance change amount which has a value within a range with the greatest value from 300 and 400.

Therefore, for example, since the capacitance change amount of the object 50 which is shown in FIG. 3a and has touched the touch screen 110 is 90, the touch level may be calculated as the first level. Since the capacitance change amount of the object 50 which is shown in FIG. 3b and has touched the touch screen 110 is 310, the touch level may be calculated as the fourth level.

Here, the first level may be a hovering level in accordance with the embodiment. Here, the configuration of the level according to the at least one of the magnitude of the touch pressure and touch area may be changed depending on the embodiment. For example, the level may be composed of only the hovering and direct touch, or the level may include the hovering and various levels.

The non-stepwise touch level will be described. The controller 130 may calculate the non-stepwise touch level in accordance with the capacitance change amount according to the at least one of the magnitude of the touch pressure and touch area. For instance, the non-stepwise touch level may have the size of the capacitance change amount as it is or the value of the touch time period as it is or may have a normalized value of a predetermined maximum value.

The correlation between the stepwise touch level and/or non-stepwise touch level and at least one of the magnitude of the touch pressure and touch area may be stored in the memory 140.

The memory 140 according to the embodiment of the present invention may store moving speed information corresponding to the stepwise touch level and/or non-stepwise touch level. Here, the controller 130 receives a moving speed corresponding to the at least one of the detected magnitude of the touch pressure and touch area from the memory 140 and changes the moving speed of the object to be displayed on the touch screen. Here, the controller 130 may control the display driver to display that the object to be displayed on the touch screen of the terminal 100 moves at the changed speed.

FIG. 5 is a flowchart showing a method for controlling the moving direction of the display object according to the embodiment of the present invention.

Referring to FIG. 5, the method for controlling the moving direction of the display object according to the embodiment of the present invention includes detecting the position of the touch input to the touch screen (S100), determining whether the touch satisfies a scroll mode entry condition or not (S200), setting the moving direction of the object to be displayed on the touch screen as a direction corresponding to the touch position (S300), and displaying that the object to be displayed on the touch screen moves in the set moving direction, on the touch screen (S400).

In determining the scroll mode entry condition (S200), the touch input to the touch screen is able to perform various functions, for example, performs an icon corresponding to the touch position, performs a link corresponding to the touch position, or the like. Therefore, it is possible to determine whether or not the input touch performs a function to move the object to be displayed on the touch screen. Specifically, the scroll mode entry condition may be that the touch time period of the input touch is greater than a predetermined period of time. When the input touch satisfies the scroll mode entry condition, the touch which is input to the touch screen performs a function to move the object to be displayed on the touch screen. Accordingly, the setting the moving direction (S300) and the displaying (S400) are performed. Here, for the purpose of making it possible for the user to recognize that the scroll mode entry condition is satisfied, the scroll mode may be displayed on the touch screen. Specifically, the scroll mode may be a whole or partial touch screen of which at least one of the brightness and chroma has been changed. The partial touch screen of which at least one of the brightness and chroma is changed may be a scroll input area to be described below.

Here, the method for controlling the moving direction of the display object according to the embodiment of the present invention further includes detecting at least any one of the magnitude of the touch pressure and touch area, and setting the moving speed of the object to be displayed on the touch screen as a speed corresponding to at least any one of the magnitude of the touch pressure and touch area. The displaying may display that the object to be displayed on the touch screen moves in the set moving direction and at the set speed, on the touch screen.

This will be described in detail with reference to the embodiments below.

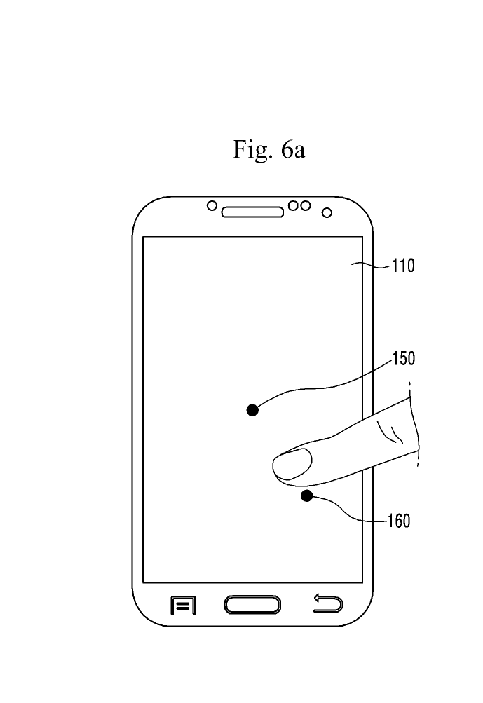

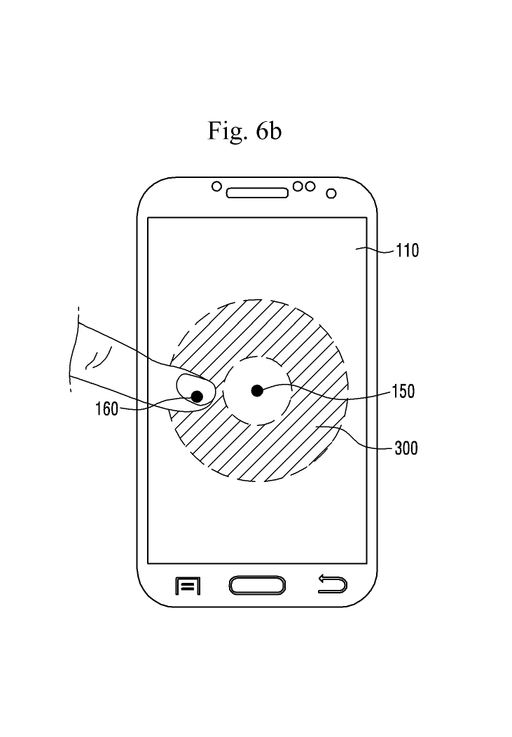

FIGS. 6a and 6b show an example of the method for controlling the moving direction of the display object according to a first embodiment.

Referring to FIGS. 6a and 6b, when the touch is input to the touch screen 110, a touch position 160 of the input touch is detected (S100).

Then, it is determined whether the touch input to the touch screen 110 satisfies the scroll mode entry condition or not (S200). When the touch input to the touch screen 110 satisfies the scroll mode entry condition, the moving direction of is set as a direction corresponding to the touch position 160 (S300). Specifically, as shown in FIG. 6a, the moving direction of the object to be displayed on the touch screen 110 may be set as a direction toward the center 150 of the touch screen 110 from the touch position 160. Here, there is no limit to the touch position 160 of the touch input to set the moving direction of the object to be displayed on the touch screen 110. The touch can be input to the entire area of the touch screen 110.

Then, that the object to be displayed on the touch screen 110 moves in the set moving direction is displayed on the touch screen 110 (S400). As such, when the touch is input to the touch screen 110, the object to be displayed on the touch screen moves toward the center 150 of the touch screen 110 from the touch position 160, so that the touch screen is scrolled in the direction of the touch position 160 with respect to the center 150 of the touch screen 110.

Here, a scroll input area 300 may be set in some parts of the touch screen 110. Specifically, when the touch position 160 is located in the central portion of the touch screen 110, the error of the moving direction, which is caused by the error of the touch position 160, is relatively large, so that the touch screen may not be scrolled in the direction that the user wants. Therefore, as shown in FIG. 6b, the scroll input area 300 may be set in an area other than the central portion of the touch screen 110.

In this case, the touch position 160 of the touch which is input to set the moving direction of the object to be displayed on the touch screen 110 is limited to the scroll input area 300. When the touch position 160 is not located within the scroll input area 300, the display object does not move, and when the touch position 160 is located within the scroll input area 300, the object to be displayed on the touch screen 110 moves toward the center 150 of the touch screen 110 from the touch position 160, so that the touch screen is scrolled in the direction of the touch position 160 with respect to the center 150 of the touch screen 110.

Also, when the touch is input to the touch screen 110, at least one of the magnitude of the touch pressure and touch area can be detected. Then, the moving speed of the object to be displayed on the touch screen 110 may be set corresponding to at least any one of the magnitude of the touch pressure and touch area. Specifically, the stepwise touch level and/or non-stepwise touch level are calculated, which correspond to the at least any one of the magnitude of the touch pressure and touch area, and then the moving speed of the object to be displayed on the touch screen 110 may be set corresponding to the calculated stepwise touch level and/or non-stepwise touch level.

Then, the touch screen 110 displays that the object to be displayed on the touch screen 110 moves in the moving direction and at the moving speed (S400). Here, when the moving speed of the object to be displayed is intended to be changed, the moving speed of the object to be displayed can be changed by controlling the magnitude of the touch pressure and/or touch area.

As such, since it is possible to scroll the object to be displayed in random directions in accordance with the touch position 160, the embodiment of the present invention can be applied to an application like a map which can be scrolled in random directions.

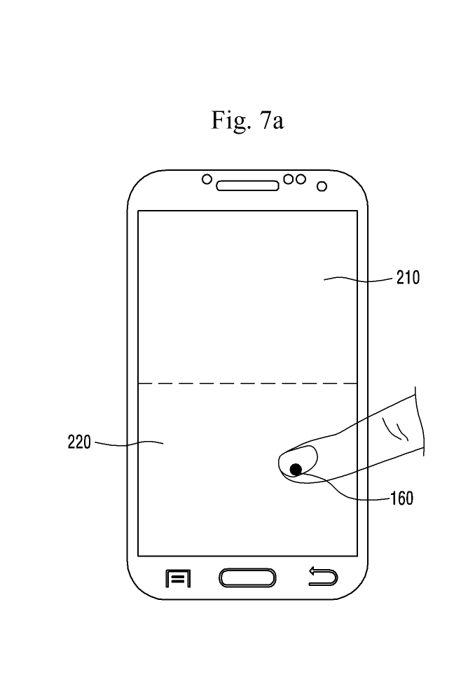

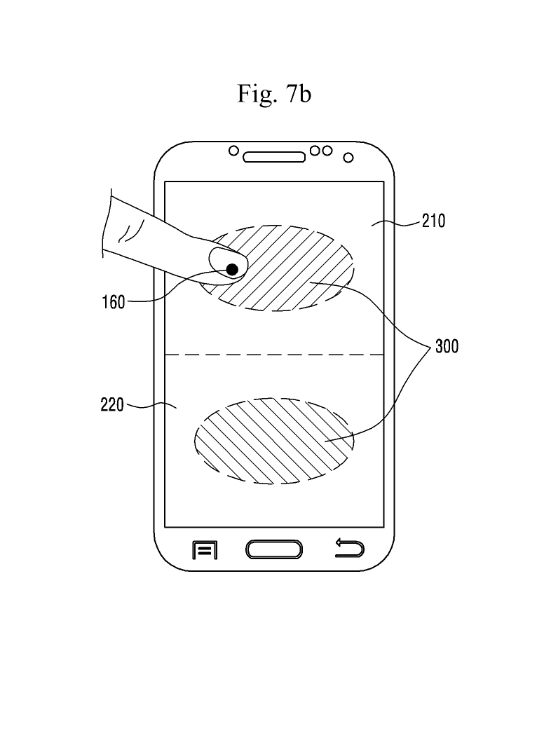

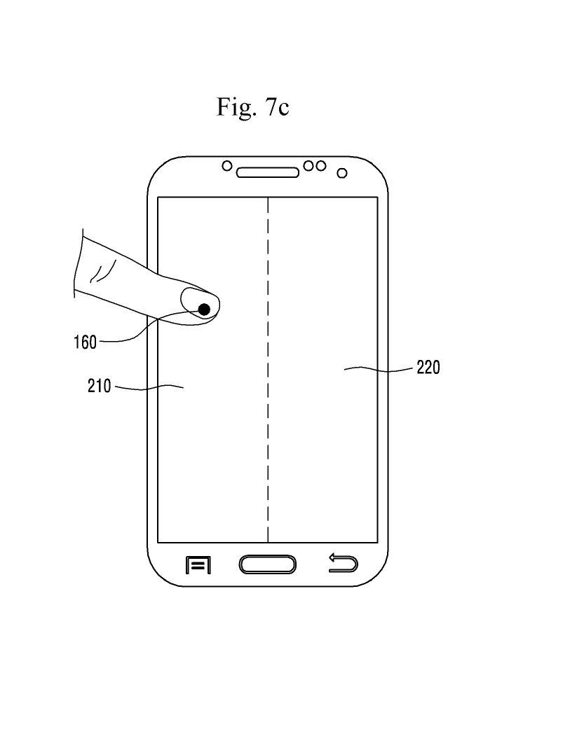

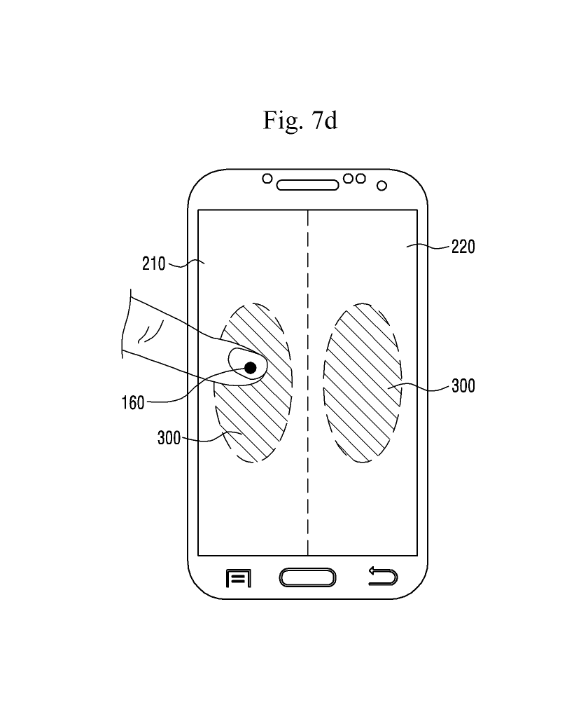

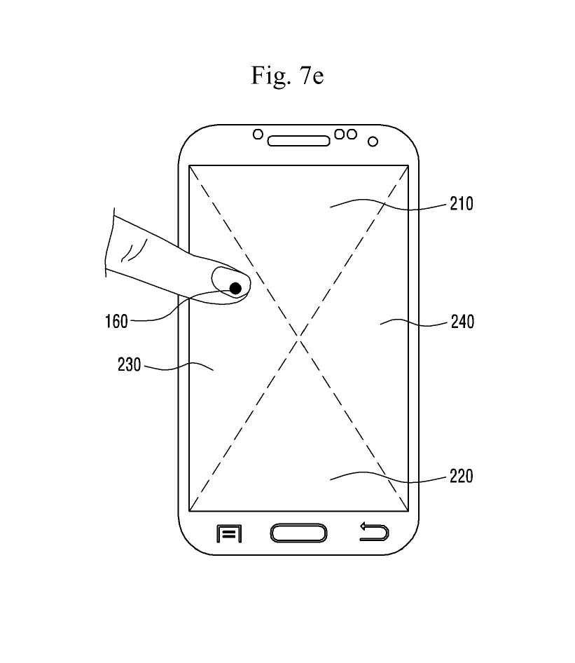

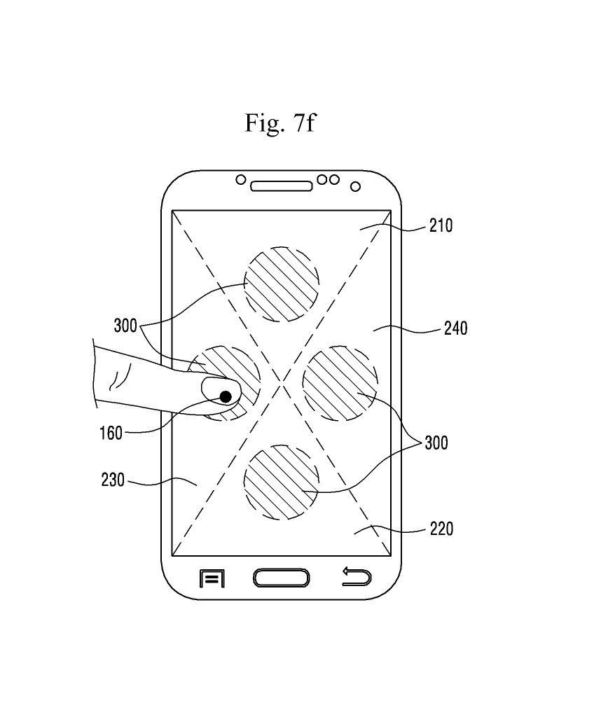

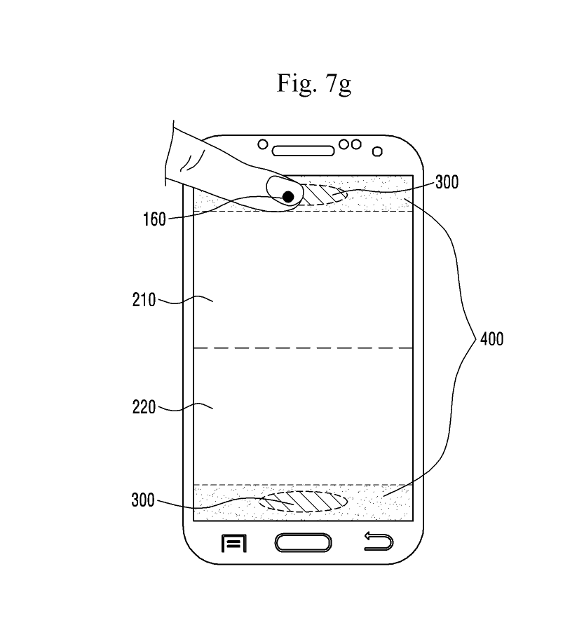

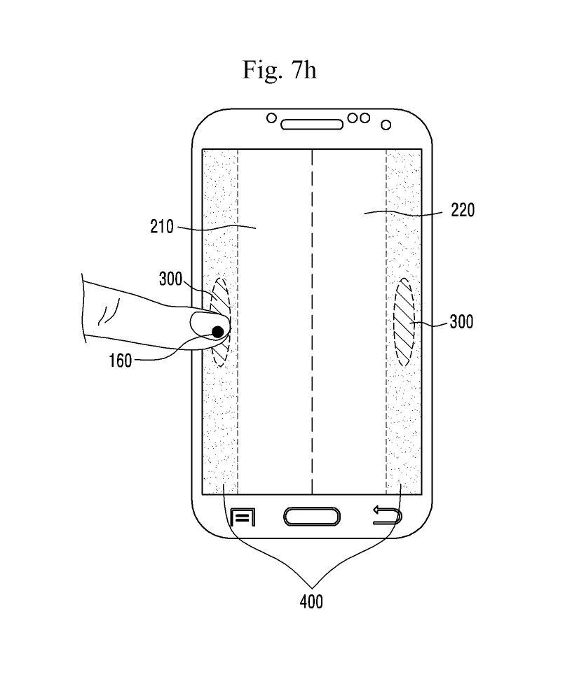

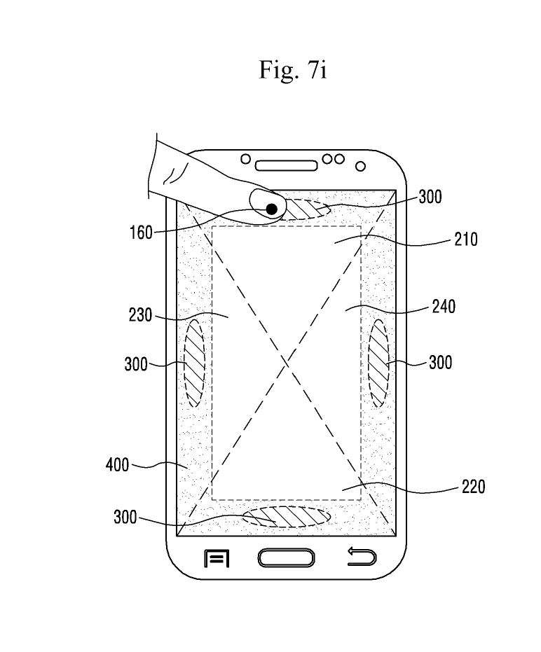

FIGS. 7a to 7i show an example of a method for controlling the moving direction of the display object according to a second embodiment.

Referring to FIGS. 7a to 7i, when the touch is input to the touch screen 110, the touch position 160 of the input touch is detected (S100).

Then, it is determined whether the touch input to the touch screen 110 satisfies the scroll mode entry condition or not (S200). When the touch input to the touch screen 110 satisfies the scroll mode entry condition, the moving direction of is set as a direction corresponding to the touch position 160 (S300). Here, the touch screen 110 may be divided into a plurality of areas.

Specifically, as shown in FIGS. 7a and 7c, the plurality of areas may include a first area 210 located in a first direction of the touch screen 110 and a second area 220 located opposite to the first area 210 with respect to the center of the touch screen 110, that is, located in a second direction opposite to the first direction. Specifically, as shown in FIG. 7a, on the basis of the horizontal central axis of the touch screen 110, the first area 210 may be located on the upper part of the touch screen and the second area 220 may be located on the lower part of the touch screen. Also, as shown in FIG. 7c, on the basis of the vertical central axis of the touch screen 110, the first area 210 may be located on the left side of the touch screen and the second area 220 may be located on the right side of the touch screen.

Also, as shown in FIG. 7e, the plurality of areas may further include a third area 230 located in a third direction of the touch screen 110 and a fourth area 240 located opposite to the third area 230 with respect to the center of the touch screen 110, that is, located in a fourth direction opposite to the third direction. Here, on the basis of the center of the touch screen 110, the first area 210 may be located on the upper part of the touch screen, the second area 220 may be located on the lower part of the touch screen, the third area 230 may be located on the left side of the touch screen, and the fourth area 240 may be located on the right side of the touch screen.

The moving direction of the object to be displayed on the touch screen 110 may be set as a direction set in the area where the touch position 160 is located. A direction in the first area 210 is a direction from the center of the first area 210 to the center of the touch screen 110. A direction set in the second area 220 is a direction from the center of the second area to the center of the touch screen 110. Specifically, when the touch position 160 is located within the first area 210, the moving direction of the object to be displayed on the touch screen 110 may be set as the second direction, and when the touch position 160 is located within the second area 220, the moving direction of the object to be displayed on the touch screen 110 may be set as the first direction. Likewise, when the touch position 160 is located within the third area 230, the moving direction of the object to be displayed on the touch screen 110 may be set as the fourth direction, and when the touch position 160 is located within the fourth area 240, the moving direction of the object to be displayed on the touch screen 110 may be set as the third direction. Here, there is no limit to the touch position 160 of the touch input to set the moving direction of the object to be displayed on the touch screen 110. The touch can be input to the entire area of the touch screen 110.

Then, that the object to be displayed on the touch screen 110 moves in the set moving direction is displayed on the touch screen 110 (S400). As such, when the touch is input to the touch screen 110, the object to be displayed on the touch screen moves in an opposite direction to the area where the touch position 160 is located, so that the touch screen is scrolled in the direction of the touch position 160.

Here, the scroll input area 300 may be set in the some parts of the touch screen 110. Specifically, when the touch position 160 is located at the boundary of the plurality of areas, the touch screen may not be scrolled in the direction that the user wants due to the error of the touch position 160. Accordingly, as shown in FIGS. 7b, 7d and 7f, the scroll input area 300 may be set in an area other than the boundary of the plurality of divided areas of the touch screen 110.

In this case, the touch position 160 of the touch which is input to set the moving direction of the object to be displayed on the touch screen 110 is limited to the scroll input area 300. When the touch position 160 is not located within the scroll input area 300, the display object does not move, and when the touch position 160 is located within the scroll input area 300, the object to be displayed on the touch screen 110 moves in an opposite direction to the area where the touch position 160 is located, so that the touch screen is scrolled in the direction of the touch position 160.

Here, the scroll input area 300 may be disposed within an edge area 400 of the touch screen 110. Specifically, when the scroll input area 300 is not located within the edge area 400 of the touch screen 110, it may not be easy to distinguish between the movement of the object to be displayed on the touch screen 110, which is performed by the touch which is input to the touch screen 110, and operations other than the movement of the object. Therefore, as shown in FIGS. 7g to 7i, the scroll input area 300 may be disposed within the edge area 400 of the touch screen 110.

Also, when the touch is input to the touch screen 110, at least one of the magnitude of the touch pressure and touch area can be detected. Then, the moving speed of the object to be displayed on the touch screen 110 may be set corresponding to at least any one of the magnitude of the touch pressure and touch area. Specifically, the stepwise touch level and/or non-stepwise touch level are calculated, which correspond to the at least any one of the magnitude of the touch pressure and touch area, and then the moving speed of the object to be displayed on the touch screen 110 may be set corresponding to the calculated stepwise touch level and/or non-stepwise touch level.

Then, the touch screen 110 displays that the object to be displayed on the touch screen 110 moves in the moving direction and at the moving speed (S400). Here, when the moving speed of the object to be displayed is intended to be changed, the moving speed of the object to be displayed can be changed by controlling the magnitude of the touch pressure and/or touch area.

As such, since it is possible to scroll the object to be displayed in a predetermined direction in accordance with the touch position 160, the embodiment of the present invention can be applied to an application like a general document, a telephone directory, or the like which can be scrolled in a predetermined direction.

In the foregoing, when the moving speed of the object to be displayed is changed in accordance with the touch area, it is possible to change the moving speed of the object to be displayed according to the embodiment even without a hardware device capable of detecting the touch pressure. Meanwhile, when the moving speed of the object to be displayed is changed according to the magnitude of the touch pressure, there is an advantage of linearly controlling the magnitude of the touch pressure. Also, it is relatively easy for the user to control the magnitude of the pressure of the touch input to the touch screen in order to cause the display object to move at a speed that the user wants. Furthermore, even when an object like a conductive rod is used, the magnitude of the touch pressure can be easily controlled.

The features, structures and effects and the like described in the embodiments are included in at least one embodiment of the present invention and are not necessarily limited to one embodiment. Furthermore, the features, structures, effects and the like provided in each embodiment can be combined or modified in other embodiments by those skilled in the art to which the embodiments belong. Therefore, contents related to the combination and modification should be construed to be included in the scope of the present invention.

Although embodiments of the present invention were described above, these are just examples and do not limit the present invention. Further, the present invention may be changed and modified in various ways, without departing from the essential features of the present invention, by those skilled in the art. For example, the components described in detail in the embodiments of the present invention may be modified. Further, differences due to the modification and application should be construed as being included in the scope and spirit of the present invention, which is described in the accompanying claims.

What is claimed is:

1. A method for controlling a moving direction of a display object, the method comprising:
detecting a position of a touch input to a touch screen;
determining whether the touch satisfies a scroll mode entry condition or not;
setting, when the touch satisfies the scroll mode entry condition, the moving direction of the object to be displayed on the touch screen as a direction based on the touch position; and
displaying that the object moves in the moving direction, on the touch screen.

2. The method of claim 1, wherein the scroll mode entry condition is that a time period of the touch is greater than a predetermined period of time.

3. The method of claim 1, wherein the setting the moving direction is setting the moving direction of the object as a direction toward the center of the touch screen from the touch position.

4. The method of claim 3, wherein the setting the moving direction comprises determining whether or not the touch position is located within a scroll input area set in a portion of the touch screen, and wherein, when the touch position is located within the scroll input area, the moving direction of the object is set as a direction toward the center of the touch screen from the touch position.

5. The method of claim 1, wherein the touch screen is divided into a plurality of areas, and wherein the setting the moving direction is setting the moving direction of the object as a direction set in the area where the touch position is located.

6. The method of claim 5, wherein the plurality of areas comprise a first area and a second area located opposite to the first area with respect to the center of the touch screen, wherein a direction set in the first area is a direction from the center of the first area to the center of the touch screen, and wherein a direction set in the second area is a direction from the center of the second area to the center of the touch screen.

7. The method of claim 5, wherein the setting the moving direction comprises determining whether or not the touch position is located within a scroll input area set respectively in a portion of the plurality of areas, and wherein, when the touch position is located within the scroll input area, the moving direction of the object is set as a direction set in the area where the touch position is located.

8. The method of claim 7, wherein the plurality of areas comprise a first area and a second area located opposite to the first area with respect to the center of the touch screen, wherein a direction set in the first area is a direction from the center of the first area to the center of the touch screen, and wherein a direction set in the second area is a direction from the center of the second area to the center of the touch screen.

9. The method of claim 7, wherein the scroll input area is disposed within an edge area of the touch screen.

10. The method of claim 9, wherein the plurality of areas comprise a first area and a second area located opposite to the first area with respect to the center of the touch screen, wherein a direction set in the first area is a direction from the center of the first area to the center of the touch screen, and wherein a direction set in the second area is a direction from the center of the second area to the center of the touch screen.

11. The method of claim 1, wherein, when the touch satisfies the scroll mode entry condition, the scroll mode is displayed on the touch screen.

12. The method of claim 11, wherein the scroll mode is a whole or partial touch screen of which at least one of the brightness and chroma has been changed.

13. The method of claim 1, further comprising:
detecting at least any one of the magnitude of the touch pressure and touch area; and
setting the moving speed of the object as a speed corresponding to at least any one of the magnitude of the touch pressure and touch area,
wherein the displaying is displaying that the object moves in the set moving direction and at the set speed, on the touch screen.

14. A terminal comprising:
a touch screen;
a processor which detects a position of a touch input to the touch screen; and
a controller which sets a moving direction of an object to be displayed on the touch screen as a direction based on the touch position when the touch satisfies a scroll mode entry condition.
